(19) United States
(12) Patent Application Publication
(10) Pub. No.: US 2006/0083262 A1
(43) Pub. Date: Apr. 20, 2006

(54) Method and apparatus to facilitate use of a pool of internet protocol 6to4 address prefixes

(75) Inventors: Ravideep Bhatia, West Dundee, IL (US); Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/964,909

(22) Filed: Oct. 14, 2004

(51) Int. Cl. H04L 12/56

(52) U.S. Cl. 370/466; 370/395.52

(57) ABSTRACT

One or more Internet Protocol version 4 addresses are selectively modified (for example, by logical movement of a subnet boundary) to thereby alter the number of characters as comprise the address. This permits logical modification of a corresponding Internet Protocol 6to4 address prefix. This permits expansion or contraction of the logical size of the Internet Protocol 6to4 address prefix and hence permits creation and subsequent manipulation and use of corresponding pools of such address prefixes.

### TECHNICAL FIELD

This invention relates generally to Internet Protocol address prefixes and more particularly to Internet Protocol 6to4 address prefixes.

### BACKGROUND

Extranets, such as the Internet, facilitate communications through use of a variety of standardized protocols and addressing schemes. These protocols and addressing schemes often evolve and change over time to meet increased needs for capacity, speed, features, and/or flexibility. As one example, Internet Protocol version 4 (IPv4) provides for an address having a 32 bit length. An ever increasing demand for unique addresses led, in part, to adoption of Internet Protocol version 6 (IPv6) which, amongst numerous other improvements and enhancements, provides for increased address space to meet the anticipated demands for this resource.

Although IPv6 indeed meets numerous demands and requirements of system operators and their user base, IPv4-compliant equipment presently comprises a large installed operational base. While the relative endpoints of a given Internet exchange (i.e., mobile nodes, access points, packet data serving nodes, and so forth) are often upgradable and/or are replaced often enough to support a shift from IPv4 to IPv6, much of the presently installed IPv4 infrastructure that comprises the Internet will not likely be replaced or upgraded at a similar pace. As a result, while many users and system purveyors may be ready, willing, and able to use and support IPv6-based network communications, key portions of the network fabric would nevertheless be incompatible to some critical extent due to this IPv4 legacy.

Transition methodologies exist to address such concerns. For example, IPv6 over IPv4 encapsulation comprises one way to compatibly connect IPv6 islands using an IPv4 network. 6to4 (as specified in Request For Comment 3056) comprises an address assignment and router-to-router automatic tunneling technology that facilitates unicast IPv6 connectivity between IPv6 sites and hosts across the largely IPv4-based Internet. The Internet Assigned Numbers Authority supports 6to4 through use of a special IPv6 prefix (often denoted as 2002::/16) followed by 32 bits that can accommodate the IPv4 address of the gateway for a given network. So configured, the IPv4 address facilitates guiding the 6to4 packet to the correct destination address (i.e., the IPv4 address of the gateway for the destination network).

While such techniques indeed permit compatible communications between IPv6 endpoints via an IPv4 infrastructure, such an approach is still sometimes hampered by remaining (or newly introduced) issues. With respect to 6to4 as noted above, the corresponding standard further provides for a 16 bit unique prefix that is locally assigned by the corresponding endpoint (such as a packet data serving node). To facilitate use of this prefix resource (on behalf of mobile nodes, for example) an endpoint will usually have access to a pool of available prefixes. Unfortunately, a 16 bit pool of prefixes will only accommodate a relatively small fixed number of unique prefixes and this upper limit (which, for a 16 bit space, is 2¹⁶) may be too small to permit convenient and intuitive administration when dealing with a relatively large number of users. For example, when a given network accommodates one or more domains that each support more than 2¹⁶ users, multiple pools of prefixes must be separately maintained and administered to meet their needs. While doable, administering multiple pools to support a common user group nevertheless represents an added processing burden that can at least increase network complexity and can even lead to a corresponding misuse or error.

### BRIEF DESCRIPTION OF THE DRAWINGS

The above needs are at least partially met through provision of the method and apparatus to facilitate use of a pool of Internet Protocol 6to4 address prefixes described in the following detailed description, particularly when studied in conjunction with the drawings, wherein:

FIG. 1 comprises a schematic depiction of a prior art 6to4 address format;

FIG. 2 comprises a flow diagram as configured in accordance with various embodiments of the invention;

FIG. 3 comprises a flow diagram as configured in accordance with various embodiments of the invention;

FIG. 4 comprises a schematic diagram as corresponds to modification of an IPv4 address and corresponding prefix space as configured in accordance with various embodiments of the invention;

FIG. 5 comprises a schematic diagram as corresponds to modification of an IPv4 address and corresponding prefix space as configured in accordance with various embodiments of the invention;

FIG. 6 comprises a schematic diagram as corresponds to modification of an IPv4 address and corresponding prefix space as configured in accordance with various embodiments of the invention;

FIG. 7 comprises a schematic diagram as corresponds to modification of an IPv4 address and corresponding prefix space as configured in accordance with various embodiments of the invention; and

FIG. 8 comprises a block diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein. It should also be noted that the word “prefix” as used herein usually refers to the 16 bit 6to4 prefix and/or the entire 16-bit to 64-bit IPv6 prefix.

### DETAILED DESCRIPTION

Pursuant to these various embodiments, upon provisioning at least one Internet Protocol version 4 address, one then creates at least one 6to4 supernet based on a plurality of such Internet Protocol version 4 addresses and/or creates a plurality of 6to4 subnets based on at least one such Internet Protocol version 4 address. In a preferred approach, logical partitioning facilitates the creation of such subnets and/or supernets.

Generally speaking, pursuant to various preferred embodiments, one or more pools of IP 6to4 address prefixes can be configured and used. Pursuant to a preferred approach, one determines whether to logically modify a predetermined number of characters as comprise an available IPv4 address to thereby alter the number of potential logical IP 6to4 address prefixes as comprise an available pool of IP 6to4 address prefixes.

In particular, altering the logical number of characters as comprise the IPv4 addresses as are used in a given system will concurrently effect an alteration of the logical number of characters as are then available to specify a given IP 6to4 address prefix, as the total space available to accommodate both the IPv4 address and the IP 6to4 address prefix in a given instance will preferably remained fixed. Accordingly, logically decreasing the character space available for IPv4 addresses by a given value X will result in a corresponding increase in the character space available for IP 6to4 addresses by this same amount X. Pursuant to a preferred approach, logical movement of a corresponding subnet boundary will yield such results.

Such an approach has particular potency when IPv4 addresses that are numerically contiguously sequential to one another are available. For example, logically moving a subnet boundary to combine a sequentially shifting portion of such IPv4 addresses with an initial pool of IP 6to4 address prefixes will yield a logical pool of IP 6to4 address prefixes that is larger than the initial pool of IP 6to4 address prefixes. This increased pool, in turn, can ease and often better facilitate administration of a relatively large user group.

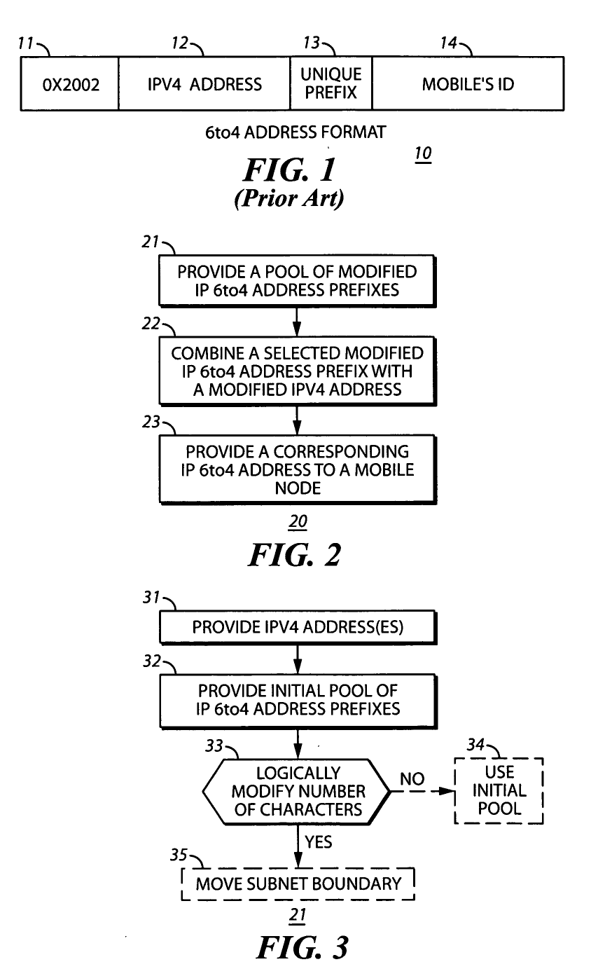

These and other benefits may become more evident upon making a thorough review and study of the following detailed description. Referring now to the drawings, and in particular to FIG. 1, it may be helpful to first describe in greater detail the existing 6to4 address format 10. The complete 6to4 address format 10 comprises 128 bits that are generally parsed with respect to four fields. A first field, representing 16 bits, contains the above-mentioned 0×2002 special IPv6 prefix 11. The second field contains 32 bits and accommodates an IPv4 address 12 (as assigned, for example, to a given endpoint). The third field contains 16 bits and comprises the locally assigned unique prefix 13 described above. The last field utilizes 64 bits to express the identifier (ID) 14 such as an interface identifier (IID) for a given individual node (such as, but not limited to, a mobile node).

As an illustrative use of such an address format 10, a mobile node can transmit to a 6to4 packet data serving node an IPv6 packet in the format just described that contains a 6to4 source and a 6to4 destination address. The packet data serving node will then extract the above-mentioned 32 bit IPv4 address from the IPv6 6to4 destination address and determine, for example, whether that IPv4 address is in a 6to4 endpoints list as maintained by (or for) that packet data serving node. When true, the packet data serving node will encapsulate the IPv6 packet in an IPv4 packet and send it to the corresponding 6to4 endpoint via an IPv4 network. Upon then receiving a responsive IPv6 communication via that tunnel, the packet data serving node can then check the corresponding IPv4 address against its 6to4 list. Upon confirming a match, the packet data serving node can then decapsulate the packet and pass it on to the appropriate mobile node.

Referring now to FIG. 2, pursuant to these teachings and an overall preferred process 20, a pool of modified IP 6to4 address prefixes are provided 21. In a preferred approach, each such modified IP 6to 4 address prefix is comprised of an identical predetermined number of characters (such as a particular number of bits). Also in a preferred approach these modified IP 6to4 address prefixes have been logically modified with respect to an initial predetermined number of characters as comprised the initial IP 6to4 address prefixes. For example, the initial predetermined number of characters can comprise the 16 bits as are presently allocated by current practice for IP 6to4 address prefixes pursuant to 6to4 address formatting. As will be described in more detail below, such logical modification can be preferably accomplished by logical movement of a subnet boundary that defines such IP 6to4 address prefix with respect to a corresponding IPv4 address.

The size of the pool so provided 21 can vary greatly and in accord with the present or anticipated needs of a given system, domain, or the like. In a preferred approach at least a substantial portion of the individual elements of the pool are members of a contiguous sequence of values, though other configurations can be accommodated if so desired.

This process 20 then effects combining 22 a selected one of the modified IP 6to4 address prefixes with a modified version of a corresponding IPv4 address to provide at least a portion of an IP 6to4 address. This result is then provided 23 to a mobile node for use by the mobile node or is otherwise used or distributed to effect the desired functionality and capability.

There are various ways to accommodate this provision 21 of a pool of modified IP 6to4 address prefixes. Referring now to FIG. 3, a preferred process will be described in more detail. This provisioning 21 can comprise the provision 31 of one or more IPv4 addresses (and preferably a plurality of such IPv4 addresses). In a preferred approach, this step comprises providing a plurality of IPv4 addresses that are numerically contiguously sequential to one another. As a simplified schematic example, the following three addresses are each seen to be contiguously sequential with respect to one another:

A.B.C.0000

A.B.C.0001

A.B.C.0010

The described provisioning 21 also comprises providing 32 an initial pool of IP 6to4 address prefixes wherein each address prefix is preferably comprised of an identical predetermined number of characters. For example, each address prefix in this initial pool can be comprised of 16 bits in accord with present practice.

This process then determines 33 whether to logically modify the predetermined number of characters of the IPv4 address (or addresses) as were provided above. When not true, this step 33 can lead to optional use 34 of the original initial pool of resources without logical modification. This may be appropriate, for example, when a good match already exists as between system needs and present system address prefixes exists.

This determination 33 can be based upon one or more criteria as appropriate to the needs of a given application. For example, this determination 33 can be made as a function, at least in part, of how many domains are to be served by the available pool of IP 6to4 address prefixes and/or the relative size of the domain or domains to be so served. So configured, for example, a determination can be made to effect such logical modification to thereby increase the size of a logical pool of available IP 6to4 address prefixes when a corresponding domain has a need for a quantity of address prefixes that exceeds the present number of address prefixes that can be uniquely combined with a given shared IPv4 address.

Such logical modification will, if pursued, effect a concurrent alteration of the number of characters as logically comprise each of the plurality of IP 6to4 address prefixes. This, in turn, can have the effect of thereby altering the effective number of potential logical IP 6to4 address prefixes as comprise the available pool of IP 6to4 address prefixes. (When more than a single IPv4 address is available, this decision 33 can include, if desired, a determination regarding whether to logically modify each such address, or only some of the addresses. Also, if desired, this decision 33 can include a determination regarding whether to logically modify each address that is to be modified in an identical manner.) As will be shown below in more detail, this can comprise a decision to logically reduce, or to logically increase, the effective number of characters as comprise both the IPv4 addresses and the IP 6to4 address prefixes.

Upon determining 33 to effect a logical modification as suggested above, this process 21 can then support such modification as appropriate to the specifications and requirements of a given application. For example, in an appropriate context, the subnet boundary as separates the IPv4 address from a corresponding IP 6to4 address prefix in the 6to4 address format can be logically moved 35.

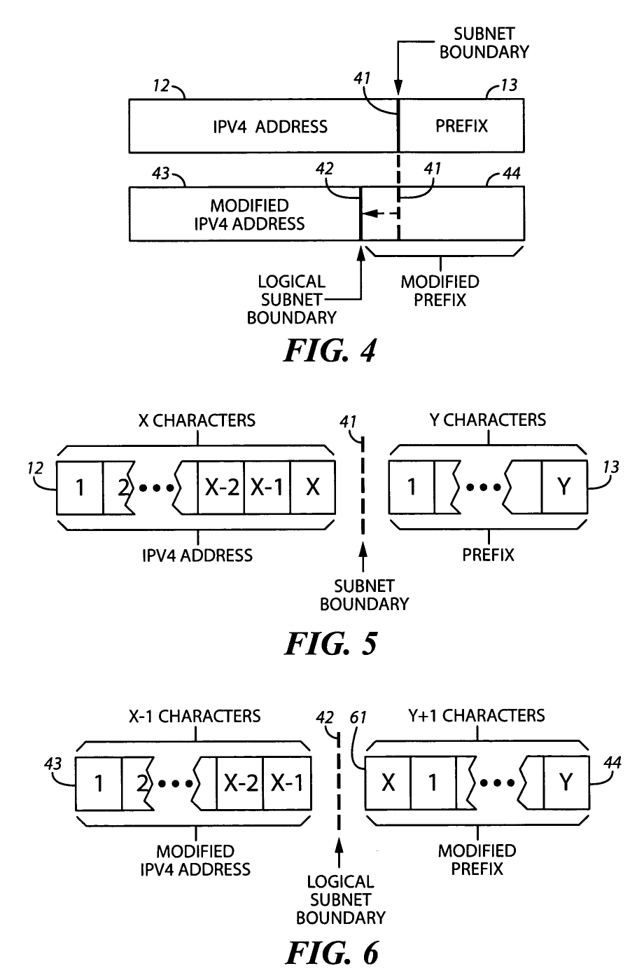

To illustrate this notion, and referring now to FIG. 4, the subnet boundary 41 as separates the IPv4 address 12 from the IP 6to4 address prefix 13 can be logically moved to thereby form a logical subnet boundary 42. This logical subnet boundary 42 in turn gives rise to a modified IPv4 address 72 and a modified prefix 44. In this particular example, where the logical subnet boundary 42 exists within the space of the original IPv4 address 12, it will be readily observed that the effective size of the modified prefix 44 increases as compared to the original prefix 13. This, in turn, increases the number of characters as comprise the IP 6to4 address prefix.

To illustrate this latter point with greater clarity, and referring now to FIG. 5, the unmodified standard IPv4 address 12 comprises X characters (with X corresponding to “32” given presently applicable standards) and the IP 6to4 address prefix 13 comprises Y characters (with Y corresponding to “16” given presently applicable standards) when separated by a conventional subnet boundary 41. With reference to FIG. 6, by moving the subnet boundary to form a new logical subnet boundary 42, the least significant character X 61 of the original IPv4 address 12 logically becomes a part of the modified prefix 44, thereby increasing the number of characters as comprise the IP 6to4 address prefix to Y+1.

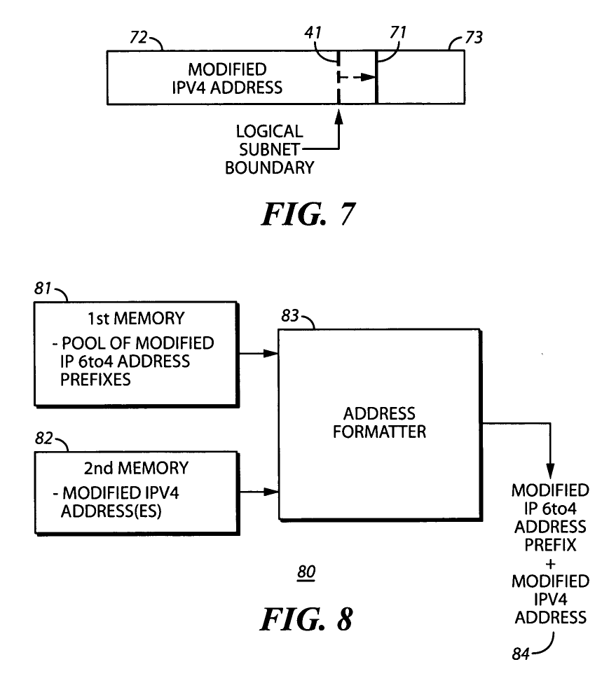

The subnet boundary 41 can be moved in the opposite direction if desired, of course, as illustrated in FIG. 7. In such a case, the logical subnet boundary 71 will yield a modified logical prefix 73 having a reduced number of bits and a modified logical IPv4 address 72 having an increased number of bits.

These teachings are particularly useful when applied in conjunction with sequentially contiguous IPv4 addresses. For example, consider the following two schematically represented addresses:

A.B.C.0000

A.B.C.0001
and, for the purpose of illustration, an initial pool of IP 6to4 address prefixes that each comprise a 4 bit prefix from 0000 to 1111. By logically placing a subnet boundary one character/bit inwards of the IPv4 address space, the logical size of the prefix grows from 4 bits to 5, and now spans:

$$00000$$

$$00001$$

$$00010$$

$$⋮$$

$$01111$$

$$10000$$

$$10001$$

$$⋮$$

$$11111.$$

This logically expanded pool of IP 6to4 address prefixes of course does not represent an actual increase in the total number of address prefixes as are available to a given system operator. This pool of logically modified IP 6to4 address prefixes, however, is now viewable, manipulable, severable, and assignable as a single contiguous pool of prefixes and this, in turn, can lead to considerably eased management strictures.

For example, such an expanded (or contracted, if desired) pool of prefixes can be associated with a specific domain (such as ABC.com, YYY.com, or the like) or a particular group of users or devices. To support such an association the logical pool can and preferably will have a name associated therewith which name can be used, for example, by an authentication, authorization, and accounting network element when communicating with a packet data service node. (Other possibilities are also available to permit the authentication, authorization, and accounting network element to return the indication of the appropriate prefix to a packet data serving node. For example, in addition or in lieu of returning a logical pool name as suggested above, this network element could return a partial or complete IPv6 prefix and/or IPv4 address or IPv4 address pool name. This skilled in the art will readily understand that these teachings are generally applicable to any such communication protocol.) These teachings are therefore seen to permit a large number of users as correspond to a given domain to nevertheless be associated with only a single logical pool of IP 6to4 address prefixes.

As a more specific illustrative example, for the domain DOMAIN1.com, a pool might be configured as 210.1.1.0/30. This means that four sequentially contiguous IPv4 addresses are available for the users of DOMAIN1.com—210.1.1.0-210.1.1.3. Within each IPv4 address, 2¹⁶ users can be uniquely supported. Corresponding prefixes are:

2002:d201:0100:0000-2002:d201:0100:ffff

2002:d201:0101:0000-2002:d201:0101:ffff

2002:d201:0102:0000-2002:d201:0102:ffff

2002:d201:0103:0000-2002:d201:0103:ffff

By applying these teachings with respect to such an initial allotment of resources, one can readily generate a single logical pool, bearing a shared pool name, that will support 2¹⁶*4 users.

It may also be desirable under at least some operating circumstances, such as when a given domain has considerably fewer than 2¹⁶ users, to apply these teachings in a way that further divides the contiguous space of 2¹⁶ prefixes into smaller portions. For example, logical movement of the subnet boundary as per these teachings can yield the following uniquely named pools as correspond to a specific domain:

2002:8111:ea5c:1000::/52—for DOMAIN1.com

2002:8111:ea5c:2000::/52—for DOMAIN2.com

2002:8111:ea5c:3000::/52—for DOMAIN3.com

2002:8111:ea5c:4000::/52—for DOMAIN4.com

The processes described herein can be carried out in any number of ways. Pursuant to one approach, and referring now to FIG. 8, a first and second memory 81 and 82 serve to retain, respectively, a pool of modified IP 6to4 address prefixes and at least one correspondingly modified IPv4 address. (Those skilled in the art will recognize that these two memories can comprise separate discrete platforms if desired but can also comprise a shared memory platform or a more distributed storage architecture as may best suit the needs and/or limitations of a given setting.) An address formatter 83 operably couples to these first and second memories 81 and 82 and provides an output 84 comprising a combination of a selected one of the modified IP 6to4 address prefixes with the modified IPv4 address. This combination can of course comprise formatting these elements as appropriate to correspond to a given protocol or standard such as the IP 6to4 address format. These actions can be attended by a packet data serving node but those skilled in the art will understand and appreciate that some or all of these actions may be well handled by other network elements.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of configuring a pool of Internet Protocol 6to4 address prefixes comprising:
providing at least one Internet Protocol version 4 address comprised of an initial predetermined number of characters;
providing an initial pool of Internet Protocol 6to4 address prefixes, wherein the Internet Protocol 6to4 address prefixes are each comprised of an identical predetermined number of characters;
determining whether to logically modify the predetermined number of characters of the at least one Internet Protocol version 4 address to thereby alter the number of characters that logically comprise each of the plurality of Internet Protocol 6to4 address prefixes and thereby alter a number of potential logical Internet Protocol 6to4 address prefixes as comprise the pool of Internet Protocol 6to4 address prefixes.

2. The method of claim 1 wherein providing at least one Internet Protocol version 4 address further comprises providing a plurality of Internet Protocol version 4 addresses.

3. The method of claim 2 wherein determining whether to logically modify the predetermined number of characters of the at least one Internet Protocol version 4 address further comprises determining whether to logically modify the predetermined number of characters of each of the plurality of Internet Protocol version 4 addresses.

4. The method of claim 3 wherein determining whether to logically modify the predetermined number of characters of each of the plurality of Internet Protocol version 4 addresses further comprises determining whether to logically modify the predetermined number of characters of each of the plurality of Internet Protocol version 4 addresses in an identical manner.

5. The method of claim 4 wherein providing a plurality of Internet Protocol version 4 addresses further comprises providing a plurality of Internet Protocol version 4 addresses that are numerically contiguously sequential to one another.

6. The method of claim 1 and further comprising:
upon determining to logically modify the predetermined number of characters of the at least one Internet Protocol version 4 address, moving a subnet boundary as separates the at least one Internet Protocol version 4 address from a corresponding one of the Internet Protocol 6to4 address prefixes.

7. The method of claim 6 wherein moving a subnet boundary as separates the at least one Internet Protocol version 4 address from a corresponding one of the Internet Protocol 6to4 address prefixes further comprises moving a subnet boundary as separates the at least one Internet Protocol version 4 address from a corresponding one of the Internet Protocol 6to4 address prefixes to logically increase the number of characters as comprise the Internet Protocol version 4 address and to thereby logically decrease the number of characters as comprise the corresponding one of the Internet Protocol 6to4 address prefixes.

8. The method of claim 6 wherein moving a subnet boundary as separates the at least one Internet Protocol version 4 address from a corresponding one of the Internet Protocol 6to4 address prefixes further comprises moving a subnet boundary as separates the at least one Internet Protocol version 4 address from a corresponding one of the Internet Protocol 6to4 address prefixes to logically decrease the number of characters as comprise the Internet Protocol version 4 address and to thereby logically increase the number of characters as comprise the corresponding one of the Internet Protocol 6to4 address prefixes.

9. The method of claim 6 wherein:
providing at least one Internet Protocol version 4 address further comprises providing a plurality of Internet Protocol version 4 addresses that are numerically contiguously sequential to one another; and
moving a subnet boundary further comprises moving the subnet boundary to logically combine a sequentially shifting portion of the Internet Protocol version 4 addresses with the initial pool of Internet Protocol 6to4 address prefixes to thereby form a logical pool of Internet Protocol 6to4 address prefixes that is larger than the initial pool of Internet Protocol 6to4 address prefixes.

10. A method to facilitate use of Internet Protocol 6to4 address prefixes comprising:
providing a pool of modified Internet Protocol 6to4 address prefixes, wherein the modified Internet Protocol 6to4 address prefixes are each comprised of an identical predetermined number of characters and wherein the pool of modified Internet Protocol 6to4 address prefixes comprises a pool of initial Internet Protocol 6to4 address prefixes that have been logically modified with respect to an initial predetermined number of characters as comprised the initial Internet Protocol 6to4 address prefixes by logical movement of a subnet boundary that defines each Internet Protocol 6to4 address prefix with respect to a corresponding Internet Protocol version 4 address;
combining a selected one of the modified Internet Protocol 6to4 address prefixes with a modified version of the corresponding Internet Protocol version 4 address to provide at least a portion of an Internet Protocol 6to4 address;
providing the at least a portion of an Internet Protocol 6to4 address to a mobile node for use by the mobile node.

11. The method of claim 10 wherein the logical movement of the subnet boundary comprises a movement that logically reduces a number of characters as comprise the corresponding Internet Protocol version 4 address to thereby provide the modified version of the Internet Protocol 6to4 address.

12. The method of claim 10 wherein the logical movement of the subnet boundary comprises a movement that logically increases a number of characters as comprise the corresponding Internet Protocol version 4 address to thereby provide the modified version of the Internet Protocol 6to4 address.

13. The method of claim 10 wherein providing a pool of modified Internet Protocol 6to4 address prefixes, wherein the modified Internet Protocol 6to4 address prefixes are each comprised of an identical predetermined number of characters and wherein the pool of modified Internet Protocol 6to4 address prefixes comprises a pool of initial Internet Protocol 6to4 address prefixes that have been logically modified with respect to an initial predetermined number of characters as comprised the initial Internet Protocol 6to4 address prefixes by logical movement of a subnet boundary further comprises:
providing a pool of modified Internet Protocol 6to4 address prefixes, wherein the modified Internet Protocol 6to4 address prefixes are each comprised of an identical predetermined number of characters and wherein the pool of modified Internet Protocol 6to4 address prefixes comprises a pool of initial Internet Protocol 6to4 address prefixes that have been logically modified with respect to an initial predetermined number of characters as comprised the initial Internet Protocol 6to4 address prefixes by logical movement of a subnet boundary as a function, at least in part, of at least one domain to be serviced by the pool.

14. An apparatus to facilitate use of Internet Protocol 6to4 address prefixes comprising:
a first memory having a pool of modified Internet Protocol 6to4 address prefixes stored therein, wherein the modified Internet Protocol 6to4 address prefixes are each comprised of an identical predetermined number of characters and wherein the pool of modified Internet Protocol 6to4 address prefixes comprises a pool of initial Internet Protocol 6to4 address prefixes that have been logically modified with respect to an initial predetermined number of characters as comprised the initial Internet Protocol 6to4 address prefixes by logical movement of a subnet boundary that defines each Internet Protocol 6to4 address prefix with respect to a corresponding Internet Protocol version 4 address;
a second memory having at least one modified Internet Protocol version 4 address stored therein;
an address formatter that is operably coupled to the first memory and the second memory and having an address output comprising a combination of a selected one of the modified Internet Protocol 6to4 address prefixes with the modified Internet Protocol version 4 address.

15. The apparatus of claim 14 wherein the logical movement of the subnet boundary comprises a movement that logically reduces a number of characters as comprise the corresponding Internet Protocol version 4 address to thereby provide the modified version of the Internet Protocol 6to4 address.

16. The apparatus of claim 14 wherein the logical movement of the subnet boundary comprises a movement that logically increases a number of characters as comprise the corresponding Internet Protocol version 4 address to thereby provide the modified version of the Internet Protocol 6to4 address.

17. The apparatus of claim 14 wherein the address formatter further comprises address formatting means for combining the selected one of the modified Internet Protocol 6to4 address prefixes with the modified Internet Protocol version 4.

18. The apparatus of claim 14 wherein the apparatus comprises a packet data serving node.

19. A method comprising:
provisioning at least one Internet Protocol version 4 address;
creating at least one of:
at least one 6to4 supernet based on at least two of the Internet Protocol version 4 addresses;
a plurality of 6to4 subnets based on at least one of the Internet Protocol version 4 addresses.

20. The method of claim 19 wherein provisioning at least one Internet Protocol version 4 address comprises provisioning a plurality of Internet Protocol version 4 addresses.

21. The method of claim 20 wherein provisioning a plurality of Internet Protocol version 4 addresses further comprises provisioning a plurality of Internet Protocol version 4 addresses that are numerically contiguously sequential to one another.

22. A method for use by an authentication, authorization, and accounting network element, comprising:
determining a need for an Internet Protocol version 6 prefix;
responding to the need by transmitting at least one of:
an indication that an Internet Protocol version 4 pool address should be used when provisioning the Internet Protocol version 6 prefix;
an indication that an Internet Protocol version 4 address should be used when provisioning the Internet Protocol version 6 prefix;
an indication that a prefix pool should be used when provisioning the Internet Protocol version 6 prefix.

23. The method of claim 22 wherein determining a need further comprises receiving a RADIUS Access Request message.

24. The method of claim 23 wherein receiving a RADIUS Access Request message further comprises receiving a RADIUS Access Request message from a packet data serving node.

25. The method of claim 22 wherein transmitting further comprises transmitting a RADIUS Access Accept message.

26. The method of claim 25 wherein transmitting a RADIUS Access Accept message further comprises transmitting a RADIUS Access Accept message to a packet data serving node.

27. The method of claim 22 wherein the Internet Protocol version 4 pool address corresponds to at least one 6to4 supernet that is based on at least two Internet Protocol version 4 addresses.

28. The method of claim 22 wherein the prefix pool corresponds to a plurality of 6to4 subnets that are based on at least one Internet Protocol version 4 address.
